(19) United States
(12) Patent Application Publication
(10) Pub. No.: US 2025/0257170 A1
(43) Pub. Date: Aug. 14, 2025

(54) WATERBORNE LIGNIN-BASED POLYURETHANE DISPERSIONS, RELATED COMPOSITIONS, AND RELATED METHODS

(71) Applicants: BOARD OF TRUSTEES OF MICHIGAN STATE UNIVERSITY, East Lansing, MI (US); MONTANA STATE UNIVERISTY, Bozeman, MT (US); THE GOVERNING COUNCIL OF THE UNIVERSITY OF TORONTO, Toronto (CA)

(72) Inventors: Mojgan Nejad, Okemos, MI (US); Saeid Nikafshar, East Lansing, MI (US); David Hodge, Bozeman, MT (US); Emma Master, Toronto (CA); Maryam Arefmanesh, Toronto (CA); Eric Linke Hegg, East Lansing, MI (US)

(21) Appl. No.: 18/833,441

(22) PCT Filed: Jan. 27, 2023
(86) PCT No.: PCT/US23/61420

§ 371 Date: Jul. 26, 2024

Related U.S. Application Data
(60) Provisional application No. 63/304,548, filed on Jan. 28, 2022.

(51) Int. Cl. C08G 18/64; C08G 18/08; C08G 18/34; C08G 18/65; C08G 18/73; C08G 18/75; C09D 175/04; C09J 175/04

(52) U.S. Cl. CPC C08G 18/6492; C08G 18/0866; C08G 18/348; C08G 18/6541; C08G 18/73; C08G 18/755; C09D 175/04; C09J 175/04

(57) ABSTRACT

The disclosure relates to waterborne polyurethane dispersions as well as related coated articles and methods. The dispersion includes a liquid or aqueous water-containing medium and polyurethane particles dispersed therein. The polyurethane particles include a reaction product between an isocyanate, a lignin (or unmodified lignin) having an aliphatic hydroxyl content of at least 2 mmol/g, optionally a natural oil polyol, and optionally an internal emulsifier. The polyurethane dispersion can have a high solids loading and typically includes a large fraction of biobased and/or environmentally friendly components, polyurethane dispersion can be applied as a layer on a substrate, for example as a coating or adhesive.

### CROSS REFERENCE TO RELATED APPLICATION

Priority is claimed to U.S. Provisional Application No. 63/304,548 (filed Jan. 28, 2022), which is incorporated herein by reference in its entirety.

### STATEMENT OF GOVERNMENT INTEREST

This invention was made with government support under DE-EE0008148 awarded by the U.S. Department of Energy. The government has certain rights in the invention.

### BACKGROUND OF THE DISCLOSURE

### Field of the Disclosure

The disclosure relates to waterborne polyurethane dispersions as well as related coated articles and methods. The dispersion includes a liquid or aqueous water-containing medium and polyurethane particles dispersed therein. The polyurethane particles include a reaction product between an isocyanate, a lignin (or unmodified lignin) having an aliphatic hydroxyl content of at least 2 mmol/g, optionally a natural oil polyol, and optionally an internal emulsifier.

### Brief Description of Related Technology

Polyurethanes (PU) are synthesized based on the chemical reaction between a diisocyanate with a di-or polyol, a compound containing more than one hydroxyl group, as shown in FIG. 1. Isocyanate compounds are categorized based on their structures (aromatic and aliphatic). MDI (methylene diphenyl diisocyanate) and TDI (toluene diisocyanate) are the aromatic isocyanates most commonly used in PU globally. HDI (hexamethylene diisocyanate) and IPDI (isophorone diisocyanate) are aliphatic isocyanates commonly used for coating formulations because coatings formulated with aromatic isocyanates are sensitive to UV degradation. Aromatic isocyanates are more reactive than aliphatic isocyanates due to the delocalization of electron density in the aromatic rings and are usually used in PU adhesive and foam formulations.

PU coatings are used for wood, metal, plastic, leather, and textile applications. The automotive and transportation industries are the leading consumer of PU coatings due to their high dielectric strength and high chemical, heat, and weather resistance properties. The global market size of PU was $60.5 billion in 2017, with an estimated annual growth rate of 8-10%. As the global market of polyols shows strong growth, the demand for biobased polyols such as lignin is increasing.

There are several challenges in incorporating lignin into polyurethane. Lignin has a complex structure in which not all hydroxyl groups are accessible to react with isocyanate due to steric hindrance. In addition, lignin has three different hydroxyl groups, including aliphatic, aromatic, and carboxylic acid groups, which have different reactivity toward isocyanate in the following order: primary aliphatic>secondary aliphatic>>phenolic>carboxylic (—COOH). Therefore, these variations limit the control of the reaction and the performance of final products. Besides, lignin has a relatively high polydispersity index (PDI), which causes the final products to have inconsistent properties due to the low homogeneity of lignin polymeric chains.

Lignins derived from different sources and isolation methods, including wheat straw, organosolv, and kraft lignin have been used to partially (40-80 wt. %) replace polyol in PU resin formulations used for coating applications. Different modification approaches such as solvent fractionation, depolymerizations, and functionalization have been used to improve the suitability of lignin as polyol replacement in polyurethane formulations. In cases where petroleum-based polyol has been partially replaced with unmodified lignin, all formulated resins were designed for solvent-borne systems, which require a high amount of organic solvents (2-3 times the weight ratio of lignin) to dissolve lignin. Such solvent-based systems dissolved lignin first in tetrahydrofuran (THF) or dimethylformamide (DMF) before PU formulation, which caused the final resin to contain about 40-60 wt. % volatile organic compound (VOC). Reducing VOC emissions is a goal in most industries. Thus, there a need to develop lignin-based polyurethane systems that meet the requirement of green chemistry in formulating zero or low VOC waterborne resins.

Waterborne polyurethane dispersions (PUD) are used as coatings for wood, plastic, metallic, and mineral substrates. PUD is a polyurethane polymer resin dispersed in water rather than solvent due to its hydrophilic functional groups. PUD has attracted great interest in coating applications due to its excellent flexibility, impact and abrasion resistance, and low VOC content.

PUDs are classified into two groups based on their synthesis method: (1) PUDs are first synthesized in a water-miscible organic solution, then water is added to the resin, or (2) PUDs are synthesized in the presence of water. In both groups, a medium molecular weight isocyanate-terminated prepolymer (i.e., polymer chains containing active isocyanate functional groups in the structure) is formed by reacting di-or poly-ols and a (molar) excess of di-or poly-isocyanates. In this way, the formed prepolymer is chemically active for further reactions. The main differences between the two methods in PUD systems are how the prepolymer chain is extended. In the first method, the water-solubilizing/dispersing groups from an internal emulsifier are functionalized (neutralized) in the prepolymer before chain extension. Then, the water is added to the polymer, and stable small particle dispersions are obtained without using an external surfactant. Later on, the solvent is removed to obtain the desired PUD system. This PUD system is not chemically active and can be directly applied on substrate. In the second method, the PUD is synthesized by adding di-or poly-amines in the aqueous phase to the isocyanate-terminated PU prepolymer for chain extension. Chain extension with an amine is possible because amine groups in polyamine are more reactive towards isocyanates than water. It is essential to keep the water temperature low enough to maintain this reactivity preference.

Biobased PUD systems have been developed using castor oil, linseed oil, canola oil, tung oil, and cardanol, which all are edible feedstock and not desirable by the industry as they compete with food sources. Unmodified alkali lignin dissolved in DMF has been used to replace 25-33 wt. % of petroleum-based polyol to synthesize a PUD resin, and it was found that introducing alkaline lignin in PUD formulation improved the thermal stability and tensile strength of PUD films.

### SUMMARY

In one aspect, the disclosure relates to a waterborne polyurethane dispersion (PUD) comprising: a liquid medium (e.g., an aqueous liquid medium) comprising water; and a polyurethane (e.g., polyurethane particles) dispersed in the aqueous medium, the polyurethane comprising a reaction product between monomer components (or reactants) comprising: an isocyanate, and a lignin (or unmodified lignin) comprising aliphatic hydroxyl groups and having an aliphatic hydroxyl content of at least 2 mmol/g or at least 4 mmol/g (e.g., and up to 8 or 10 mmol/g); wherein the reaction product comprises urethane linking groups between residues of the lignin aliphatic hydroxyl groups and the isocyanate. Optional co-monomer components can include natural oil polyols, an internal emulsifier, etc. The final polyurethane polymer typically has no or substantially no remaining isocyanate groups and/or aliphatic hydroxyl groups, such groups having been essentially completely reacted and polymerized to form the various urethane/carbamate linking groups in the final polyurethane polymer. The final polyurethane polymer can include some residual, unreacted phenol hydroxyl groups and/or carboxylic acid groups, for example present in the original lignin prior to reaction and remaining in the polyurethane due to their low reactivity with isocyanate groups.

Various refinements of the disclosed polyurethane polymer and corresponding waterborne polyurethane dispersion are possible.

In a refinement, the isocyanate comprises a diisocyanate, for example an isocyanate selected from the group consisting of hexamethylene diisocyanate (HDI), isophorone diisocyanate, 4,4′-diphenylmethane diisocyanate (MDI), polymeric methylene diphenyl diisocyanate (pMDI), one or more isomers of tolylene diisocyanate (TDI), and combinations thereof.

More generally, the isocyanate is not particularly limited and generally can include any aromatic, alicyclic, and/or aliphatic monomeric, oligomeric, and/or polymeric isocyanates having at least two reactive isocyanate groups (—NCO) (e.g., di-or higher poly-functional isocyanates). Suitable isocyanates contain on average 2-4 isocyanate groups. In some embodiments, the isocyanate includes a diisocyanate. In some embodiments, the isocyanate includes triisocyanate. Suitable diisocyanates can have the general structure (O═C═N)—R—(N═C═O), where R can include aromatic, alicyclic, and/or aliphatic groups, for example having at least 2, 4, 6, 8, 10 or 12 and/or up to 8, 12, 16, or 20 carbon atoms. Examples of specific isocyanates include 1,5-naphthylene diisocyanate, 4,4′-diphenylmethane diisocyanate (MDI), hydrogenated MDI, polymeric methylene diphenyl diisocyanate (pMDI), xylene diisocyanate (XDI), tetramethylxylol diisocyanate (TMXDI), 4,4′-diphenyl-dimethylmethane diisocyanate, di-and tetraalkyl-diphenylmethane diisocyanate, 4,4′-dibenzyl diiso-cyanate, 1,3-phenylene diisocyanate, 1,4-phenylene diisocyanate, one or more isomers of tolylene diisocyanate (TDI, such as toluene 2,4-diisocyanate), 1-methyl-2,4-diiso-cyanatocyclohexane, 1,6-diisocyanato-2,2,4-trimethyl-hexane, 1,6-diisocyanato-2,4,4-trimethylhexane, 1-iso-cyanatomethyl-3-isocyanato-1,5,5-trimethylcyclohexane, chlorinated and brominated diisocyanates, phosphorus-containing diisocyanates, 4,4′-diisocyanatophenyl-perfluoroethane, tetramethoxybutane 1,4-diisocyanate, butane 1,4-diisocyanate, hexane 1,6-diisocyanate (or hexamethylene diisocyanate; HDI), HDI dimer (HDID), HDI trimer (HDIT), HDI biuret, dicyclohexylmethane diisocyanate, cyclohexane 1,4-diisocyanate, ethylene diisocyanate, phthalic acid bisisocyanatoethyl ester, 1-chloromethylphenyl 2,4-diisocyanate, 1-bromomethylphenyl 2,6-diisocyanate, 3,3-bischloromethyl ether 4,4′-diphenyldiisocyanate, trimethylhexamethylene diisocyanate, 1,4-diisocyanato-butane, 1,2-diisocyanatododecane, and combinations thereof. The isocyanate can be biobased or made of synthetic feedstock. Examples of suitable biobased isocyanates include pentamethylene diisocyanate trimer, and isocyanates formed from base compounds to which isocyanate groups are attached (e.g., via suitable derivatization techniques), including isocyanate-terminated poly (lactic acid) having two or more isocyanate groups, isocyanate-terminated poly (hydroxyalkanaotes) having two or more isocyanate groups, isocyanate-terminated biobased polyesters having two or more isocyanate groups.

In a refinement, the (unmodified) lignin is derived from a hardwood biomass and is isolated from an alkaline (or soda) extraction process.

In a refinement, the (unmodified) lignin is derived from a biomass selected from the group consisting of hardwoods, softwoods, grasses, and combinations thereof.

In a refinement, the (unmodified) lignin is isolated from an extraction process selected from the group consisting of Kraft extraction, soda or alkaline extraction, organosolv extraction, enzymatic hydrolysis extraction, ionic liquid, extraction, sulfite extraction, and combinations thereof.

The lignin is not particularly limited and generally can include lignin from any lignocellulosic biomass. Plants, in general, are comprised of cellulose, hemicellulose, lignin, extractives, and ash. Lignin typically constitutes 15-35 wt. % of woody plant cell walls, is an amorphous aromatic polymer made of phenylpropane units (e.g., coniferyl alcohol, sinapyl alcohol, p-coumaryl alcohol). The lignin for use according to the disclosure is not particularly limited to the source of lignin or its isolation method. Any type of lignin regardless of the biomass type (hardwood, softwood, grasses, and other agricultural residues) isolated through any extraction methods (such as Kraft, soda, organosolv, sulfite, enzymatic hydrolysis, and lonic liquid) is suitable for use in the disclosed compositions and articles.

The lignin incorporated into the reaction mixture for oxyalkylation is generally an unmodified lignin. Unmodified lignin as used herein refers to lignin that has been separated from other components of its lignocellulosic biomass feedstock, such as the cellulose, hemicellulose, and other plant material components. Such separation processes (e.g., Kraft, soda, organosolv, sulfite, enzymatic hydrolysis, and ionic liquid) to isolate lignin from biomass may hydrolyze or otherwise fragment larger lignin molecules into smaller fragments, but this fragmentation and molecular weight reduction is still considered to provide an unmodified lignin as used herein in the corresponding compositions and methods. Such isolated lignins, which are also known as technical lignins, have not been subjected to further modifications or fragmentations, and are considered to provide an unmodified lignin as used herein in the corresponding compositions and methods. Modifications (or chemical modifications) that are generally avoided for the lignin used herein can include one or more of demethylation, phenolation, hydroxymethylation, etherification, depolymerization, and fractionation to monomer, dimers, trimers and oligomers.

The unmodified lignin is generally polymeric, as contrasted with various lignin monomers such as one or more of coniferyl alcohol, sinapyl alcohol, and p-coumaryl alcohol. For example, the unmodified lignin can have an average molecular weight (e.g., weight-average molecular weight, Mw) of at least 500 g/mol or at least 1000 g/mol. While technical lignins or other commercial lignins isolated from biomass could have some lignin monomers in the distribution of lignin components, the fraction of such lignin monomers in the unmodified lignin is suitably small, for example as reflected by the minimum average molecular weight of the unmodified lignin. In some embodiments, the unmodified lignin contains less than 10, 5, 2, 1, 0.5, 0.2, or 0.1 wt. % lignin monomers relative to the total unmodified lignin.

In a refinement, the (unmodified) lignin, prior to incorporation into the reaction mixture, has at least one of the following properties: a molecular weight in a range of 500 to 20000; a polydispersity in a range of 1.2 to 8; an aliphatic hydroxyl content in a range of 4 to 8 mmol/g; a phenol hydroxyl content in a range of 1 to 6 mmol/g; a carboxylic hydroxyl content less than 1 mmol/g; a total hydroxyl content in a range of 5 to 14 mmol/g; an ash content of 2 wt. % or less; and/or a carbohydrate content of 10 wt. % of less.

In a refinement, the (unmodified) lignin, prior to incorporation into the reaction mixture, has at least one of the following properties: a number-average molecular weight (Mn) in a range of 500 to 5000 (or 1000 to 3000); a polydispersity in a range of 1.2 to 8 (or 2to 4); a phenol hydroxyl content in a range of 1 to 7 mmol/g (or 2 to 5 mmol/g); a relative aliphatic hydroxyl content of at least 45% (or at least 55%) relative to hydroxyl groups of the unmodified lignin; and/or a carboxylic hydroxyl content less than 1 mmol/g (or less than 0.5 mmol/g).

More generally, the (unmodified) lignin, prior to reaction and/or incorporation into a reaction mixture for removal of water, suitably can be selected to have one or more properties related to molecular weight, molecular weight distribution, hydroxyl content, and hydroxyl content distribution. For example, a lower molecular weight and/or a lower polydispersity index can be desirable to promote access to and reactivity of the phenolic (or aromatic) hydroxy groups of the lignin, but lignin with any molecular weight and/or polydispersity can be used. Suitably, the weight-average molecular weight (Mw) can be in a range of 500 to 50000, 1000 to 3000, 3000 to 7000, 3000 to 10000, or 10000 to 50000. For example, Mw independently can be at least 500, 800, 1000, 1500, 2000, or 3000 and/or up to 1000, 1200, 1500, 2000, 3000, 5000, 7000, 10000, 15000, or 50000, but higher values are possible. Similar ranges can apply to the number-average molecular weight (Mn).

Alternatively or additionally, the polydispersity index (Mw/Mn) can be in a range of 1.2 to 10, 1.2 to 8, 1.2 to 5, or 2 to 4, for example being at least 1.2, 1.4, 1.6, 1.8, or 2 and/or up to 1.5, 1.8, 2.0, 3.0, 4.0, 5.0, 6.0, 8.0, or 10, but higher values are possible. In a refinement, the aliphatic hydroxyl content of the unmodified lignin can be in a range of 2 to 10 mmol/g, 2 to 8 mmol/g, or 4 to 8 mmol/g, for example being at least 2, 2.5, 3, 3.5, 4, or 4.5 and/or up to 4, 5, 6, 7, 8, 9, or 10 mmol/g. In a refinement, the phenol hydroxyl content of the unmodified lignin can be in a range of 1 to 7 mmol/g, 2 to 6 mmol/g, or 3 to 6 mmol/g, for example being at least 1, 1.5, 2, 2.5, 3, or 3.5 and/or up to 3, 3.5, 4, 4.5, 5, 5.5, 6, or 7 mmol/g. Alternatively or additionally, the aliphatic hydroxyl content can be at least 40, 50, 60, or 70% and/or up to 60, 65, 70, 75, or 80% of the total hydroxyl groups of the unmodified lignin (e.g., aliphatic, phenolic/aromatic, and carboxylic hydroxyl groups combined). Similarly, the aliphatic hydroxyl content individually can be greater than the phenolic hydroxyl content individually and the carboxylic hydroxyl content individually. In a refinement, the carboxylic hydroxyl content of the unmodified lignin can be less than 1 mmol/g or 2 mmol/g, for example being at least 0.01, 0.1, or 0.2 and/or up to 0.2, 0.3, 0.4, 0.5, 0.7, 1, 1.5, or 2 mmol/g. In a refinement, the total hydroxyl content of the unmodified lignin can be in a range of 2 to 14 mmol/g, 3 to 12 mmol/g, or 4 to 8 mmol/g, for example being at least 2, 2.5, 3, 3.5, 4, 4.5, 5, or 6 and/or up to 4, 5, 6, 7, 8, 9, 10, 12, or 14 mmol/g.

In a refinement, the monomer components further comprise a natural oil polyol (e.g., soy polyol); and the reaction product further comprises urethane linking groups between residues of the natural oil polyol (e.g., hydroxyl groups thereof) and the isocyanate. The natural oil polyol is generally a polyol having an (average) hydroxyl group functionality of 2 or more that is derived from vegetable oils or triglycerides, for example between 2 to 10 hydroxyl groups per natural oil polyol triglyceride or other molecule unit, such as (an average of) at least 2, 2.5, 3, 4, or 5 and/or up to 3, 3.5, 4, 6, 8, or 10 hydroxyl groups per molecule. The hydroxyl group functionalities are generally present on/pendant from the fatty acid chains in the triglyceride. The hydroxyl group functionalities can be naturally present in some natural oil polyols (e.g., ricinoleic acid residues such as in castor oil), or they can be added to natural vegetable oils by known techniques, such as by oxidation, epoxidation, ozonolysis, etc. of natural vegetable oils having unsaturated carbon-carbon double bonds (e.g., as in soybean oil, peanut oil canola oil, etc.). The natural oil polyol can have wide range of hydroxyl values from 30 to 560 mg KOH/g, for example at least 30, 50, 80, 100, 200, or 300 and/or up to 60, 90, 120, 150, 250, 350, 450, or 560 mg KOH/g.

In a further refinement, when present, the natural oil polyol can be incorporated into the reaction product in an amount of 5 wt. % to 50 wt. % relative to the lignin. For example, the natural oil polyol can be incorporated into the reaction product in an amount of at least 5, 10, 15, 20, 25, 30, or 35 wt. % and/or up to 15, 20, 25, 30, 35, 40, 45, or 50 wt. % relative to the lignin. The foregoing amount ranges likewise can apply to the amount of incorporated natural oil polyol relative to the combined amount of lignin, natural oil polyol, and internal emulsifier (i.e., total hydroxy functional components) incorporated into the reaction product. Yet further, the foregoing amount ranges likewise can apply to the amount of natural oil polyol added to a reaction mixture prior to polymerization and polyurethane formation, for example expressed as an amount relative to lignin alone or an amount relative to the combined amount of lignin, natural oil polyol, and internal emulsifier added to the reaction mixture.

In a refinement, the monomer components further comprise an internal emulsifier (e.g., tartaric acid); and the reaction product further comprises urethane linking groups between residues of the internal emulsifier (e.g., hydroxyl groups thereof) and the isocyanate. The internal emulsifier is suitably a relatively small hydrocarbon having at least 2 hydroxyl groups (or aliphatic hydroxyl groups) and at least 1 carboxylic group, for example having 2, 3, 4 hydroxyl groups; 1, 2, or 3 carboxylic groups; and/or 2-10, 3-6, or 3-4 carbon atoms in a linear or branched backbone. During formation of the polyurethane, the hydroxyl groups can react with the isocyanate to form urethane linking groups and be incorporated into the polyurethane backbone. The carboxylic groups are suitably neutralized, for example with a tertiary amine (e.g., triethylamine) neutralizing agent to provide compatibility with and stability in an aqueous/water medium due to formed ions (e.g., a quaternary ammonium analog of the tertiary amine as a counter-cation to the carboxylate anion in solution), thus serving as an emulsifier for the polyurethane. A suitable tertiary amine can be represented by NR¹R²R³, where R¹, R², and R³ can be the same or different alkyl groups having 1, 2, 3, 4 carbon atoms and/or up to 6, 8, or 10 carbon atoms. A corresponding quaternary ammonium can be represented by NR¹R²R³H⁺, where R¹, R², and R³ are as described above. Thus, in some embodiments, the internal emulsifier can comprise a quaternary ammonium group (e.g., from the original neutralizing agent) and a carboxylate group (e.g., from the original carboxylic acid group in the internal emulsifier), for example as present in the dispersion. The neutralizing agent likewise can remain in an applied, dried coating after water/solvent removal (e.g., for example in its tertiary amine form). An example of a suitable internal emulsifier includes tartaric acid, which is a natural/biobased internal emulsifier. Another suitable internal emulsifier includes dimethylol propionic acid (DMPA).

In a further refinement, when present, the internal emulsifier can be incorporated into the reaction product in an amount of 5 wt. % to 30 wt. % relative to the lignin. For example, the internal emulsifier can be incorporated into the reaction product in an amount of at least 5, 7, 10, 15, 20, or 25 wt. % and/or up to 10, 15, 20, 25, or 30 wt. % relative to the lignin. The foregoing amount ranges likewise can apply to the amount of incorporated internal emulsifier relative to the combined amount of lignin, natural oil polyol, and internal emulsifier (i.e., total hydroxy functional components) incorporated into the reaction product. Yet further, the foregoing amount ranges likewise can apply to the amount of internal emulsifier added to a reaction mixture prior to polymerization and polyurethane formation, for example expressed as an amount relative to lignin alone or an amount relative to the combined amount of lignin, natural oil polyol, and internal emulsifier added to the reaction mixture.

In a further refinement, when present, the neutralizing agent can be incorporated into the reaction product in an amount of 5 wt. % to 30 wt. % relative to the lignin. For example, the neutralizing agent can be incorporated into the reaction product in an amount of at least 5, 7, 10, 15, 20, or 25 wt. % and/or up to 10, 15, 20, 25, or 30 wt. % relative to the lignin. The foregoing amount ranges likewise can apply to the amount of incorporated neutralizing agent relative to the combined amount of lignin, natural oil polyol, and internal emulsifier (i.e., total hydroxy functional components) incorporated into the reaction product. Yet further, the foregoing amount ranges likewise can apply to the amount of neutralizing agent added to a reaction mixture after or during polymerization and polyurethane formation, for example expressed as an amount relative to lignin alone or an amount relative to the combined amount of lignin, natural oil polyol, and internal emulsifier added to the reaction mixture.

In a refinement, the lignin, the natural oil polyol (when present), and the internal emulsifier (when present) can provide substantially all of the urethane linking groups in the reaction product. The lignin, natural oil polyol (when present), and internal emulsifier (when present) can represent an essentially complete replacement for petroleum-based polyols such that essentially all of the urethane/carbamate linking groups in the polyurethane are derived from reaction products between the isocyanate and the hydroxyl groups of the lignin, natural oil polyol, or internal emulsifier. For example, at least 70, 80, 90, 95, 98, 99% and/or up to 90, 95, 98, 99, 100% of the urethane/carbamate linking groups are derived from reaction products between the isocyanate and the hydroxyl groups of the lignin, natural oil polyol, or internal emulsifier. Similarly, at least 70, 80, 90, 95, 98, 99 wt. % and/or up to 90, 95, 98, 99, 100 wt. % of the hydroxyl-containing reactants used to form the polyurethane reaction product are lignin, natural oil polyol, or internal emulsifier. Alternatively or additionally, not more than 20, 10, 5, 2, or 1% of the urethane/carbamate linking groups are derived from petroleum-based hydroxyl-containing sources or hydroxyl-containing sources other than lignins, natural oil polyols, and internal emulsifiers, for example with analogous wt. % upper limits on hydroxyl-containing reactants derived from petroleum-based hydroxyl-containing sources.

In a refinement, the lignin, the natural oil polyol (when present), and the internal emulsifier (when present) can provide only a portion of the urethane linking groups in the reaction product. In this case, the lignin, natural oil polyol (when present), and internal emulsifier (when present) can represent a partial replacement for petroleum-based polyols such that (i) a portion of the urethane/carbamate linking groups in the polyurethane are derived from reaction products between the isocyanate and the hydroxyl groups of the lignin, natural oil polyol, or internal emulsifier, and (ii) a portion of the urethane/carbamate linking groups in the polyurethane are derived from reaction products between the isocyanate and hydroxyl groups of a petroleum-based or other polyol. For example, at least 30, 40, or 50% and/or up to 50, 60, 70, 80, 90, or 95% of the urethane/carbamate linking groups are derived from reaction products between the isocyanate and the hydroxyl groups of the lignin, natural oil polyol, or internal emulsifier. Similarly, at least 30, 40, or 50 wt. % and/or up to 50, 60, 70, 80, 90, or 95 wt. % of the hydroxyl-containing reactants used to form the polyurethane reaction product are lignin, natural oil polyol, or internal emulsifier. Alternatively or additionally, at least 5, 10, 20, 30, 40, or 50% and/or up to 50, 60, or 70% of the urethane/carbamate linking groups are derived from reaction products between the isocyanate and the hydroxyl groups of the petroleum-based or other polyol. Similarly, at least 5, 10, 20, 30, 40, or 50 wt. % and/or up to 50, 60, or 70 wt. % of the hydroxyl-containing reactants used to form the polyurethane reaction product are petroleum-based or other polyols. Example petroleum-based and other polyols include diols, triols, and polyols with two, three, four, or more hydroxyl groups such as glycerol, ethylene glycol, diethylene glycol, triethylene glycol, tetraethylene glycol, propylene glycol, dipropylene glycol, tripropylene glycol, 1,3-propanediol, 1,3-butanediol, 1,4-butanediol, neopentyl glycol, 1,6-hexanediol, 1,4-cyclohexanedimethanol, glycerol, trimethylolpropane, 1,2,6-hexanetriol, and pentaerythritol, as well as polyether polyols, polyester polyols, etc.

In a refinement, the polyurethane dispersion has a solids content in a range of 10 wt. % to 50 wt. %, 25 wt. % to 60 wt. %, 30 wt. % to 70 wt. % relative to the polyurethane dispersion. For example, the polyurethane dispersion can have a solids content of at least 10, 15, 20, 25, 30, 35, 40, 45, or 50 wt. % and/or up to 20, 25, 30, 35, 40, 45, 50, 55, 60, 65, or 70 wt. % relative to the relative to the polyurethane dispersion. The solids content can reflect the weight of solid residue remaining after removal and drying of the liquid dispersion medium, including water as the primary portion of the aqueous medium and any secondary solvents, expressed relative to the initial weight of the dispersion. Alternatively, the solids content can be expressed as a weight concentration of the dispersed polyurethane reaction product relative to the total dispersion weight. Prior to final drying to form a coating or layer of the polyurethane on a substrate, the solids content of the dispersion can be increased by at least partial evaporation or removal or suspending solvents, for example removing all or substantially all of MEK or other volatile organic solvent used during polymerization as well as removal of at least some water added to the reaction product mixture to create an initial dispersion. For example, an polyurethane dispersion as initially formed upon addition of water might have a solids content of about 10 wt. %, which can be increased to about 30 wt. %, about 50 wt. %, or more by removing the volatile organic reaction medium solvent and some water, while retaining sufficient water for an aqueous medium and a stable dispersion.

In a refinement, the aqueous medium further comprises a water-miscible solvent. The aqueous liquid medium can include a secondary, water-miscible solvent, for example a biobased solvent such as cyrene (dihydrolevoglucosenone). The secondary solvent is suitably an aprotic solvent, and preferably a non-toxic biobased solvent alternative to other aprotic solvents. In some embodiments, however, the aprotic solvent can be other than biobased, for example including dimethyl formamide (DMF), dimethyl sulfoxide (DMSO), acetone, N-methyl-2-pyrrolidone (NMP), etc. The secondary solvent can be used as a co-solvent in an initial reaction mixture containing monomer components prior to polyurethane formation (e.g., in combination with MEK or other volatile organic solvent). After polyurethane formation, the volatile co-solvent such as MEK can be removed, leaving the secondary, water-miscible solvent in the dispersion to remain as part of the aqueous dispersing medium after addition of water).

In a refinement, the aqueous medium (or liquid medium) is present in the polyurethane dispersion in a range of 50 wt. % to 90 wt. %, 40 wt. % to 80 wt. %, or 30 wt. % to 70 wt. % relative to the polyurethane dispersion. For example, the aqueous medium can be present in an amount of at least 30, 35, 40, 45, 50, 55, 60, or 65 wt. % and/or up to 45, 50, 55, 60, 65, 70, 75, 80, 85, or 90 wt. % relative to the relative to the polyurethane dispersion. The foregoing ranges can reflect the combined amount of water and any additional secondary solvents present (e.g., cyrene).

In a refinement, the water is present in the aqueous medium (or liquid medium) in an amount of at least 50 wt. % relative to the aqueous medium. More generally, the amount of water can be higher or lower depending on how much water is added to form the initial dispersion and/or how much water is removed when concentrating the dispersion to obtain a desired solids loading. For example, the water can be present in an amount of at least 10, 20, 30, 40, 50, 60, 70, 80, 90, 95, or 99 wt. % and/or up to 30, 40, 50, 60, 70, 80, 90, 95, 98, or 100 wt. % relative to the aqueous or liquid medium. Similarly, any secondary or water-miscible solvent(s) can be present in an amount of at least 10, 20, 30, 40, 50, 60, 70, or 80 wt. % and/or up to 30, 40, 50, 60, 70, 80, or 90 wt. % relative to the aqueous or liquid medium.

In a refinement, the polyurethane dispersed in the aqueous medium is in the form of polyurethane particles having a size in a range of 30 nm to 200 nm. For example, the polyurethane particles can have a size of at least 30, 50, 80, or 100 nm and/or up to 70, 100, 150, or 200 nm. The foregoing ranges can represent an average size (e.g., volume, number, or weight average) or high/low for cumulative size distribution (e.g., 10/90%, 5/95% cuts of the cumulative size distribution).

In a refinement, the polyurethane dispersion is substantially free from cyclic alkyl carbonates. This can include cyclic alkyl carbonates used as a solvent and/or a reactive solvent reacts with and is incorporated into the polyurethane polymer. Thus, the polyurethane dispersion as a whole, the aqueous medium component thereof, and/or the polyurethane component thereof suitably contain not more than 10, 5, 2, 1, 0.5, 0.2, or 0.1 wt. % cyclic alkyl carbonates, whether in carbonate form or as a ring-opened and isocyanate-reacted residue in the polyurethane. Examples of representative cyclic alkyl carbonates include propylene carbonate, ethylene carbonate, trimethylene carbonate, butylene carbonates (e.g., derived from one or more butanediols such as 1,2-, 1,3-, 1,4-, or 2,3-butanediol), pentylene carbonates (e.g., derived from one or more pentanediols), etc.

In another aspect, the disclosure relates to a method making a polyurethane dispersion (e.g., in any of its variously disclosed embodiments, refinements, etc.), the method comprising: reacting a reactant mixture comprising the isocyanate, the lignin, optionally the natural oil polyol, and optionally the internal emulsifier in an organic solvent medium (e.g., cyrene and MEK), thereby forming the polyurethane reaction product in the organic solvent medium; adding water to the organic solvent medium, thereby forming dispersed polyurethane particles; and removing at least a portion of the organic solvent medium (e.g., the MEK component, leaving the cyrene component), thereby forming the aqueous medium with the polyurethane (e.g., polyurethane particles) dispersed in the aqueous medium. The initial reacting step is suitably performed under a nitrogen, argon, etc. or other inert, essentially water-free (i.e., to avoid reaction with isocyanate groups) atmosphere at an elevated temperature of about 50-100° C. Addition of the water to the organic solvent medium is suitably performed under high shear conditions (e.g., at/above 500 rpm mixing rates). Suitable co-solvents for the water-miscible solvent in the initial organic solvent medium can include acetone, methyl ethyl ketone (MEK), dioxane, acetonitrile, ethyl acetate, and tetrahydrofuran. After formation of the dispersed polyurethane particles, removal of the co-solvent (e.g., MEK) via evaporation can remove some of the added water and/or some of the water-miscible solvent.

After polymerization and prior to addition of the water, a hydrazine or other primary amine (or primary diamine) can slowly added to the reaction mixture to consume remaining isocyanate functional groups. The hydrazine or primary amine is added slowly to the isocyanate-terminated prepolymer to attach two isocyanate end groups chains together. It is preferable to reacts with two separate isocyanate-terminated prepolymer chains, but also it is possible to react with isocyanate-terminated prepolymer groups in the same molecule. The use of hydrazine is helpful to avoid or reduce the chance of second reaction.

In another aspect, the disclosure relates to an article (e.g., coated article) comprising: (a) a substrate; and (b) a polyurethane polymer (e.g., in any of its variously disclosed embodiments, refinements, etc.), coated on a surface of the substrate. The polyurethane polymer coating the polyurethane reaction product remaining as a film or layer on a substrate after drying or other removal of the aqueous medium components of the dispersion, which in turn causes the polyurethane particles in the dispersion to coalesce into a continuous coating layer. Typically, the polyurethane polymer as formed in the polyurethane dispersion is a fully reacted product and there is no chemical reaction or curing during the drying process.

In a refinement, the substrate is selected from the group of metal, plastics, a different polymer material, glass, wood, fabric (or textile), composites, and ceramics. The substrates are not particularly limited, and generally can be formed from any material(s) desired for protection, adhesion, or otherwise with a polyurethane polymer, in particular given the good, broad adhesive capabilities of the polyurethane polymer. For example, the substrate can be a metal, plastic, a different thermoset material (e.g., a primer material; material other than the other than polyurethane polymer), glass, wood, fabric (or textile), or ceramic material. Examples of specific metals include steel, aluminum, copper, etc. Examples of specific plastics include polyvinyl alcohol (PVOH), ethylene vinyl alcohol (EVOH), polyethylene terephthalate (PET), polypropylene (PP), polyethylene (PE), polylactic acid (PLA), starch, chitosan, etc. In an embodiment, the substrate can be in the form of a three-dimensionally printed substrate, whether formed from a polymeric/plastic material or otherwise. Suitable wood materials can be any type of wood commonly used in home, office, and outdoor settings. Suitable glass materials can be those used for building windows, automobile windows, etc. In some embodiments, the substrate is a top layer of a coating or series of coatings on a different underlying substrate. For example, the coated article can include a substrate material as generally disclosed herein, one or more intermediate coatings on the substrate (e.g., an epoxy coating, an acrylic coating, another primer coating, etc.), and the polyurethane polymer on the one or more intermediate coatings as the final, external coating on the coated article.

In a refinement, the polyurethane polymer has a thickness ranging from 0.01 μm to 500 μm. More generally, the polyurethane polymer can have any desired thickness on the substrate(s). In common applications, the polyurethane polymer has a thickness ranging from 0.010 μm to 500 μm, for example at least 0.01, 10, 20, 50, or 100 μm and/or up to 200,500 μm. Typical cast coatings can have thicknesses of 10 μm to 100 μm. Typical spin coatings can have thicknesses of 0.05 μm or 0.10 μm to 0.20 μm or 0.50 μm. Multiple coating layers can be applied to substrate to form even thicker layers of the polyurethane polymer (e.g., above 500 μm or otherwise) if desired.

In a refinement, article further comprising an additional substrate, wherein: the polyurethane polymer is also coated on a surface of the additional substrate, and the polyurethane polymer joins the substrate and the additional substrate together.

In another aspect, the disclosure relates to a method for forming an article or coated article (e.g., in any of its variously disclosed embodiments, refinements, etc.), the method comprising: applying a polyurethane dispersion (e.g., in any of its variously disclosed embodiments, refinements, etc.) to the substrate (e.g., via spraying, dipping, rolling, etc.); and removing the aqueous medium from the applied polyurethane dispersion (e.g., wet or liquid applied layer of dispersion, including via drying or heating a ambient or elevated temperature), thereby forming a polyurethane polymer as a layer on the substrate (e.g., the polyurethane reaction product remaining after removal of liquid dispersion components and coalescence of polyurethane particles).

While the disclosed methods, compositions, and articles are susceptible of embodiments in various forms, specific embodiments of the disclosure are illustrated (and will hereafter be described) with the understanding that the disclosure is intended to be illustrative, and is not intended to limit the claims to the specific embodiments described and illustrated herein.

### BRIEF DESCRIPTION OF THE DRAWINGS

For a more complete understanding of the disclosure, reference should be made to the following detailed description and accompanying drawings wherein:

FIG. 1 illustrate a reaction scheme between an isocyanate and a polyol to form a urethane (or carbamate) reaction product.

FIG. 2 illustrates an article including a polyurethane polymer according to the disclosure as a coating on a substrate.

FIG. 3 illustrates an article including a polyurethane polymer according to the disclosure as an adhesive joining two substrates.

FIG. 4 is a graph showing tensile properties of films formed from waterborne polyurethane dispersions according to the disclosure, including tensile strength (MPa; illustrated by bars in the figure) and elongation at break (%; illustrated by diamonds in the figure).

### DETAILED DESCRIPTION

The disclosure relates to waterborne polyurethane dispersions as well as related coated articles and methods. The dispersion includes a liquid or aqueous water-containing medium and polyurethane particles dispersed therein. The polyurethane particles include a reaction product between an isocyanate, a lignin (or unmodified lignin) having an aliphatic hydroxyl content of at least 2 mmol/g, optionally a natural oil polyol, and optionally an internal emulsifier. The polyurethane dispersion can have a high solids loading and typically includes a large fraction of biobased and/or environmentally friendly components. polyurethane dispersion can be applied as a layer on a substrate, for example as a coating or adhesive.

As disclosed herein, waterborne polyurethane dispersions (PUD) are attractive in coating applications due to excellent properties, including fast drying, excellent adhesion to different substrates, high chemical and water resistance, high abrasion resistance, outstanding flexibility and toughness, nonflammability, and low or even zero VOC content. In addition, the use of biobased polyols, including renewable materials like lignin, further provides renewable, sustainable, and environmentally friendly polyurethane formulations.

As illustrated more particularly in the examples below, lignins from alkaline pre-extraction and two-stage alkaline pre-extraction/copper-catalyzed alkaline hydrogen peroxide (Cu-AHP) pretreatment processes had high aliphatic hydroxyl content (4.2-5.1 mmol/g) were used to synthesize lignin-based PUD resins. Briefly, lignin and tartaric acid (e.g., as a biobased internal emulsifier) were dissolved in cyrene (or dihydrolevoglucosenone; a biobased, water-soluble, organic solvent made from cellulose) and methyl ethyl ketone (MEK), and then hexamethylene diisocyanate (HDI) was added to the reaction mixture. After 4 hrs reaction at 70° C. under nitrogen atmosphere, triethylamine (TEA) was added as a neutralizing agent. Hydrazine monohydrate was used to react with any remaining/residual isocyanate groups after 1 hr. Next, deionized (DI) water was added to the solution using a high shear rate mixer. In the last step, MEK was removed from the system by using a rotary evaporator. In some formulations, about 10-30 wt. % of lignin was replaced with soy-based polyol (40 mg KOH/g) to improve tensile strength and elongation at the break of prepared lignin-based PUD systems. A commercial PUD resin was used to compare with the prepared lignin-based PUDs according to the disclosure. The tensile strength and elongation at break of lignin-based PUD resin with 20 wt. % soy-polyol were similar to a commercial PUD resin. All physical and chemical properties of lignin-based PUDs, including pH, viscosity, solid content, and solvent resistance, were comparable to a commercial PUD system. The waterborne PUD formulations according to the disclosure and as illustrated in the examples have a high biobased content (lignin, soy-based polyol, tartaric acid, and cyrene), and also avoid the use of other toxic solvents like dimethylformamide (DMF) and N-methyl-2-pyrrolidone (NMP). The lignin-based, waterborne PUDs are particularly suitable for coating for various substrates such as metal and wood.

### Polyurethane Dispersion

The waterborne polyurethane dispersion (PUD) includes an aqueous or water-containing liquid medium and a polyurethane or polyurethane polymer therein, generally in the form of polyurethane particles dispersed in the aqueous medium. The polyurethane in the dispersion is generally a reaction product between an isocyanate and a lignin (or unmodified lignin) having an aliphatic hydroxyl content of at least 2 mmol/g, and optionally with one or more additional components such as a natural oil polyol, an internal emulsifier, a neutralizing agent (e.g., tertiary amine), and/or a terminating/chain extending agent (e.g., primary amine or diamine). The polyurethane reaction product includes urethane or carbamate linking groups between residues of the isocyanate and the lignin aliphatic hydroxyl groups, as well as with the hydroxyl groups of the natural oil polyols and/or internal emulsifier, when present. The polyurethane reaction product can further include urea linking groups or bonds between residues of the isocyanate and the primary (di) amino-functional terminating or chain extending agent. The final polyurethane polymer typically has no or substantially no remaining isocyanate groups and/or aliphatic hydroxyl groups, such groups having been essentially completely reacted and polymerized to form the various urethane/carbamate linking groups in the final polyurethane polymer. The final polyurethane polymer can include some residual, unreacted phenol hydroxyl groups and/or carboxylic acid groups, for example present in the original lignin prior to reaction and remaining in the polyurethane due to their low reactivity with isocyanate groups. In some embodiments, carboxylic groups in the polyurethane polymer, for example from the original lignin and/or from the internal emulsifier, can be partially or fully neutralized, such as with the inclusion of a tertiary amine neutralizing agent.

The aqueous medium (or liquid medium) is generally present in the polyurethane dispersion in a range of 50 wt. % to 90 wt. %, 40 wt. % to 80 wt. %, or 30 wt. % to 70 wt. % relative to the polyurethane dispersion. For example, the aqueous medium can be present in an amount of at least 30, 35, 40, 45, 50, 55, 60, or 65 wt. % and/or up to 45, 50, 55, 60, 65, 70, 75, 80, 85, or 90 wt. % relative to the relative to the polyurethane dispersion. The foregoing ranges can reflect the combined amount of water and any additional secondary solvents present (e.g., cyrene). Alternatively or additionally, the water can be present in the aqueous medium (or liquid medium) in an amount of at least 50 wt. % relative to the aqueous medium. More generally, the amount of water can be higher or lower depending on how much water is added to form the initial dispersion and/or how much water is removed when concentrating the dispersion to obtain a desired solids loading. For example, the water can be present in an amount of at least 10, 20, 30, 40, 50, 60, 70, 80, 90, 95, or 99 wt. % and/or up to 30, 40, 50, 60, 70, 80, 90, 95, 98, or 100 wt. % relative to the aqueous or liquid medium.

In embodiments, the aqueous medium (or liquid medium) can include a secondary solvent such as a water-miscible solvent in addition to the water. The secondary solvent can be a biobased solvent such as cyrene (dihydrolevoglucosenone). The secondary solvent is suitably an aprotic solvent, and preferably a non-toxic biobased solvent alternative to other aprotic solvents. In some embodiments, however, the aprotic solvent can be other than biobased, for example including dimethyl formamide (DMF), dimethyl sulfoxide (DMSO), acetone, N-methyl-2-pyrrolidone (NMP), etc. The secondary solvent can be used as a co-solvent in an initial reaction mixture containing monomer components prior to polyurethane formation (e.g., in combination with MEK or other volatile organic solvent). After polyurethane formation, the volatile co-solvent such as MEK can be removed, leaving the secondary, water-miscible solvent in the dispersion to remain as part of the aqueous dispersing medium after addition of water). Any secondary or water-miscible solvent(s) can be present in an amount of at least 10, 20, 30, 40, 50, 60, 70, or 80 wt. % and/or up to 30, 40, 50, 60, 70, 80, or 90 wt. % relative to the aqueous or liquid medium.

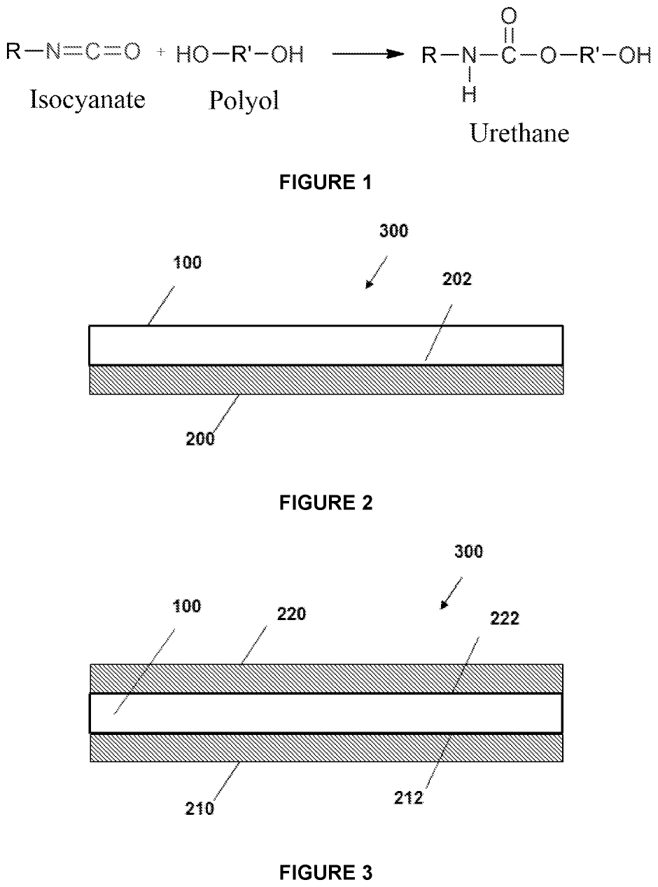

The isocyanate is not particularly limited and generally can include any aromatic, alicyclic, and/or aliphatic monomeric, oligomeric, and/or polymeric isocyanates having at least two reactive isocyanate groups (—NCO) (e.g., di-or higher poly-functional isocyanates). Suitable isocyanates contain on average 2-4 isocyanate groups. In some embodiments, the isocyanate includes a diisocyanate. In some embodiments, the isocyanate includes triisocyanate. Suitable diisocyanates can have the general structure (O═C═N)—R—(N═C═O), where R can include aromatic, alicyclic, and/or aliphatic groups, for example having at least 2, 4, 6, 8, 10 or 12 and/or up to 8, 12, 16, or 20 carbon atoms. As illustrated in FIG. 1, the isocyanate groups in the original isocyanate compound react with hydroxyl groups, whether from the lignin or the optional natural oil polyol and/or internal emulsifier, to form corresponding urethane or carbamate (—NHC(═O) O-) linking groups between reacted residues of the isocyanate and the various hydroxyl-containing reactants forming the polyurethane. Additionally, the isocyanate groups in the original isocyanate compound can react with amino groups, for example in a primary (di) amine terminating agent, to form corresponding urea (—NHC(═O)NH-) linking groups between reacted residues of the isocyanate and the terminating agent.

Examples of specific isocyanates include 1,5-naphthylene diisocyanate, 4,4′-diphenylmethane diisocyanate (MDI), hydrogenated MDI, polymeric methylene diphenyl diisocyanate (pMDI), xylene diisocyanate (XDI), tetramethylxylol diisocyanate (TMXDI), 4,4′-diphenyl-dimethylmethane diisocyanate, di-and tetraalkyl-diphenylmethane diisocyanate, 4,4′-dibenzyl diiso-cyanate, 1,3-phenylene diisocyanate, 1,4-phenylene diisocyanate, one or more isomers of tolylene diisocyanate (TDI, such as toluene 2,4-diisocyanate), 1-methyl-2,4-diiso-cyanatocyclohexane, 1,6-diisocyanato-2,2,4-trimethyl-hexane, 1,6-diisocyanato-2,4,4-trimethylhexane, 1-iso-cyanatomethyl-3-isocyanato-1,5,5-trimethylcyclohexane, chlorinated and brominated diisocyanates, phosphorus-containing diisocyanates, 4,4′-diisocyanatophenyl-perfluoroethane, tetramethoxybutane 1,4-diisocyanate, butane 1,4-diisocyanate, hexane 1,6-diisocyanate (or hexamethylene diisocyanate; HDI), HDI dimer (HDID), HDI trimer (HDIT), HDI biuret, dicyclohexylmethane diisocyanate, cyclohexane 1,4-diisocyanate, ethylene diisocyanate, phthalic acid bisisocyanatoethyl ester, 1-chloromethylphenyl 2,4-diisocyanate, 1-bromomethylphenyl 2,6-diisocyanate, 3,3-bischloromethyl ether 4,4′-diphenyldiisocyanate, trimethylhexamethylene diisocyanate, 1,4-diisocyanato-butane, 1,2-diisocyanatododecane, and combinations thereof. The isocyanate can be biobased or made of synthetic feedstock. Examples of suitable biobased isocyanates include pentamethylene diisocyanate trimer, and isocyanates formed from base compounds to which isocyanate groups are attached (e.g., via suitable derivatization techniques), including isocyanate-terminated poly (lactic acid) having two or more isocyanate groups, isocyanate-terminated poly (hydroxyalkanaotes) having two or more isocyanate groups, isocyanate-terminated biobased polyesters having two or more isocyanate groups.

The isocyanate or reacted isocyanate residues can being present in the present in the polyurethane polymer or reaction product in any suitable amount, for example in an amount of 10 wt. % to 70 wt. % or 20 wt. % to 40 wt. % relative to the polyurethane polymer or relative or solids portion of the polyurethane dispersion (i.e., excluding water, solvent, and other liquid fractions of the aqueous medium). For example, the isocyanate can be incorporated into the polyurethane reaction product in an amount of at least 10, 15, 20, 25,30, 35, or 40 wt. % and/or up to 25, 30, 35, 40, 45, 50, 55, 60, 65, or 70 wt. % relative to the polyurethane polymer. The foregoing amount ranges likewise can apply to the amount of isocyanate compound(s) added to a reaction mixture prior to polymerization and polyurethane formation, for example expressed as an amount relative to the combined amount of isocyanate, lignin, natural oil polyol, internal emulsifier, neutralizing agent, and/or terminating agent added to the reaction mixture. Alternatively or additionally, a weight ratio of the isocyanate to lignin in the polyurethane polymer or initial reaction mixture can be in a range of 0.6 to 3 or 1 to 1.6, for example at least 0.6, 0.8, 1, 1.1, 1.2, 1.3, 1.4, or 1.5 and/or up to 0.9, 1.2, 1.4, 1.6, 1.8, 2, 2.3, 2.6, or 3.

The lignin is not particularly limited and generally can include lignin from any lignocellulosic biomass. Plants, in general, are comprised of cellulose, hemicellulose, lignin, extractives, and ash. Lignin typically constitutes 15-35 wt. % of woody plant cell walls, is an amorphous aromatic polymer made of phenylpropane units (e.g., coniferyl alcohol, sinapyl alcohol, p-coumaryl alcohol). The lignin for use according to the disclosure is not particularly limited to the source of lignin or its isolation method. Any type of lignin regardless of the biomass type (hardwood, softwood, grasses, and other agricultural residues) isolated through any extraction methods (such as Kraft, soda, organosolv, sulfite, enzymatic hydrolysis, and lonic liquid) is suitable for use in the disclosed compositions and articles. In some embodiments, the lignin or unmodified lignin is derived from a hardwood biomass and/or is isolated from an alkaline (or soda) extraction process.

The lignin incorporated into the reaction mixture for polyurethane formation is generally an unmodified lignin. Unmodified lignin as used herein refers to lignin that has been separated from other components of its lignocellulosic biomass feedstock, such as the cellulose, hemicellulose, and other plant material components. Such separation processes (e.g., Kraft, soda, organosolv, sulfite, enzymatic hydrolysis, and ionic liquid) to isolate lignin from biomass may hydrolyze or otherwise fragment larger lignin molecules into smaller fragments, but this fragmentation and molecular weight reduction is still considered to provide an unmodified lignin as used herein in the corresponding compositions and methods. Such isolated lignins, which are also known as technical lignins, have not been subjected to further modifications or fragmentations, and are considered to provide an unmodified lignin as used herein in the corresponding compositions and methods. Modifications (or chemical modifications) that are generally avoided for the lignin used herein can include one or more of demethylation, phenolation, hydroxymethylation, etherification, depolymerization, and fractionation to monomer, dimers, trimers and oligomers.

The unmodified lignin is generally polymeric, as contrasted with various lignin monomers such as one or more of coniferyl alcohol, sinapyl alcohol, and p-coumaryl alcohol. For example, the unmodified lignin can have an average molecular weight (e.g., weight-average molecular weight, Mw) of at least 500 g/mol or at least 1000 g/mol. While technical lignins or other commercial lignins isolated from biomass could have some lignin monomers in the distribution of lignin components, the fraction of such lignin monomers in the unmodified lignin is suitably small, for example as reflected by the minimum average molecular weight of the unmodified lignin. In some embodiments, the unmodified lignin contains less than 10, 5, 2, 1, 0.5, 0.2, or 0.1 wt. % lignin monomers relative to the total unmodified lignin.

In a refinement, the (unmodified) lignin, prior to incorporation into the reaction mixture, has at least one of the following properties: a molecular weight in a range of 500 to 20000; a polydispersity in a range of 1.2 to 8; an aliphatic hydroxyl content in a range of 4 to 8 mmol/g; a phenol hydroxyl content in a range of 1 to 6 mmol/g; a carboxylic hydroxyl content less than 1 mmol/g; a total hydroxyl content in a range of 5 to 14 mmol/g; an ash content of 2 wt. % or less; and/or a carbohydrate content of 10 wt. % of less.

In a refinement, the (unmodified) lignin, prior to incorporation into the reaction mixture, has at least one of the following properties: a number-average molecular weight (Mn) in a range of 500 to 5000 (or 1000 to 3000); a polydispersity in a range of 1.2 to 8 (or 2to 4); a phenol hydroxyl content in a range of 1 to 7 mmol/g (or 2 to 5 mmol/g); a relative aliphatic hydroxyl content of at least 45% (or at least 55%) relative to hydroxyl groups of the unmodified lignin; and/or a carboxylic hydroxyl content less than 1 mmol/g (or less than 0.5 mmol/g).

More generally, the (unmodified) lignin, prior to reaction and/or incorporation into a reaction mixture for removal of water, suitably can be selected to have one or more properties related to molecular weight, molecular weight distribution, hydroxyl content, and hydroxyl content distribution. For example, a lower molecular weight and/or a lower polydispersity index can be desirable to promote access to and reactivity of the phenolic (or aromatic) hydroxy groups of the lignin, but lignin with any molecular weight and/or polydispersity can be used. Suitably, the weight-average molecular weight (Mw) can be in a range of 500 to 50000, 1000 to 3000, 3000 to 7000, 3000 to 10000, or 10000 to 50000. For example, Mw independently can be at least 500, 800, 1000, 1500, 2000, or 3000 and/or up to 1000, 1200, 1500, 2000, 3000, 5000, 7000, 10000, 15000, or 50000, but higher values are possible. Similar ranges can apply to the number-average molecular weight (Mn). Alternatively or additionally, the polydispersity index (Mw/Mn) can be in a range of 1.2 to 10, 1.2 to 8, 1.2 to 5, or 2 to 4, for example being at least 1.2, 1.4, 1.6, 1.8, or 2 and/or up to 1.5, 1.8, 2.0, 3.0, 4.0, 5.0, 6.0, 8.0, or 10, but higher values are possible. In a refinement, the aliphatic hydroxyl content of the unmodified lignin can be in a range of 2 to 10 mmol/g, 2 to 8 mmol/g, or 4 to 8 mmol/g, for example being at least 2, 2.5, 3, 3.5, 4, or 4.5 and/or up to 4, 5, 6, 7, 8, 9, or 10 mmol/g. In a refinement, the phenol hydroxyl content of the unmodified lignin can be in a range of 1 to 7 mmol/g, 2 to 6 mmol/g, or 3 to 6 mmol/g, for example being at least 1, 1.5, 2, 2.5, 3, or 3.5 and/or up to 3, 3.5, 4, 4.5, 5, 5.5, 6, or 7 mmol/g. Alternatively or additionally, the aliphatic hydroxyl content can be at least 40, 50, 60, or 70% and/or up to 60, 65, 70, 75, or 80% of the total hydroxyl groups of the unmodified lignin (e.g., aliphatic, phenolic/aromatic, and carboxylic hydroxyl groups combined). Similarly, the aliphatic hydroxyl content individually can be greater than the phenolic hydroxyl content individually and the carboxylic hydroxyl content individually. In a refinement, the carboxylic hydroxyl content of the unmodified lignin can be less than 1 mmol/g or 2 mmol/g, for example being at least 0.01, 0.1, or 0.2 and/or up to 0.2, 0.3, 0.4, 0.5, 0.7, 1, 1.5, or 2 mmol/g. In a refinement, the total hydroxyl content of the unmodified lignin can be in a range of 2 to 14 mmol/g, 3 to 12 mmol/g, or 4 to 8 mmol/g, for example being at least 2, 2.5,3, 3.5, 4, 4.5, 5, or 6 and/or up to 4, 5, 6, 7, 8, 9, 10, 12, or 14 mmol/g.

The lignin or reacted lignin residues can being present in the present in the polyurethane polymer or reaction product in any suitable amount, for example in an amount of 20 wt. % to 80 wt. % or 30 wt. % to 50 wt. % relative to the polyurethane polymer or relative or solids portion of the polyurethane dispersion (i.e., excluding water, solvent, and other liquid fractions of the aqueous medium). For example, the isocyanate can be incorporated into the polyurethane reaction product in an amount of at least 20, 25, 30, 35, 40, 45, or 50 wt. % and/or up to 35, 40, 45, 50, 55, 60, 65, 70, 75, or 80 wt. % relative to the polyurethane polymer. The foregoing amount ranges likewise can apply to the amount of lignin added to a reaction mixture prior to polymerization and polyurethane formation, for example expressed as an amount relative to the combined amount of isocyanate, lignin, natural oil polyol, internal emulsifier, neutralizing agent, and/or terminating agent added to the reaction mixture.

In some embodiments, a natural oil polyol (e.g., soy polyol) can be incorporated into the polyurethane polymer. In such cases, the polyurethane reaction product further includes urethane linking groups between residues of the natural oil polyol (e.g., hydroxyl groups thereof) and the isocyanate. The natural oil polyol is generally a polyol having an (average) hydroxyl group functionality of 2 or more that is derived from vegetable oils or triglycerides, for example between 2 to 10 hydroxyl groups per natural oil polyol triglyceride or other molecule unit, such as (an average of) at least 2, 2.5, 3, 4, or 5 and/or up to 3, 3.5, 4, 6, 8, or 10 hydroxyl groups per molecule. The hydroxyl group functionalities are generally present on/pendant from the fatty acid chains in the triglyceride. The hydroxyl group functionalities can be naturally present in some natural oil polyols (e.g., ricinoleic acid residues such as in castor oil), or they can be added to natural vegetable oils by known techniques, such as by oxidation, epoxidation, ozonolysis, etc. of natural vegetable oils having unsaturated carbon-carbon double bonds (e.g., as in soybean oil, peanut oil canola oil, etc.). The natural oil polyol can have wide range of hydroxyl values from 30 to 560 mg KOH/g, for example at least 30, 50, 80, 100, 200, or 300 and/or up to 60, 90, 120, 150, 250, 350, 450, or 560 mg KOH/g.

The natural oil polyol can be incorporated into the reaction product in an amount of 5 wt. % to 50 wt. % relative to the lignin. For example, the natural oil polyol can be incorporated into the reaction product in an amount of at least 5, 10, 15, 20, 25, 30, or 35 wt. % and/or up to 15, 20, 25, 30, 35, 40, 45, or 50 wt. % relative to the lignin. The foregoing amount ranges likewise can apply to the amount of incorporated natural oil polyol relative to the combined amount of lignin, natural oil polyol, and internal emulsifier (i.e., total hydroxy functional components) incorporated into the reaction product. Yet further, the foregoing amount ranges likewise can apply to the amount of natural oil polyol added to a reaction mixture prior to polymerization and polyurethane formation, for example expressed as an amount relative to lignin alone or an amount relative to the combined amount of lignin, natural oil polyol, and internal emulsifier added to the reaction mixture.

In some embodiments, an internal emulsifier (e.g., tartaric acid) can be incorporated into the polyurethane polymer. In such cases, the reaction product further includes urethane linking groups between residues of the internal emulsifier (e.g., hydroxyl groups thereof) and the isocyanate. The internal emulsifier is suitably a relatively small hydrocarbon having at least 2 hydroxyl groups (or aliphatic hydroxyl groups) and at least 1 carboxylic group, for example having 2, 3, 4 hydroxyl groups; 1, 2, or 3 carboxylic groups; and/or 2-10, 3-6, or 3-4 carbon atoms in a linear or branched backbone. During formation of the polyurethane, the hydroxyl groups can react with the isocyanate to form urethane linking groups and be incorporated into the polyurethane backbone.

The internal emulsifier can be incorporated into the reaction product in an amount of 5 wt. % to 30 wt. % relative to the lignin. For example, the internal emulsifier can be incorporated into the reaction product in an amount of at least 5, 7, 10, 15, 20, or 25 wt. % and/or up to 10, 15, 20, 25, or 30 wt. % relative to the lignin. The foregoing amount ranges likewise can apply to the amount of incorporated internal emulsifier relative to the combined amount of lignin, natural oil polyol, and internal emulsifier (i.e., total hydroxy functional components) incorporated into the reaction product. Yet further, the foregoing amount ranges likewise can apply to the amount of internal emulsifier added to a reaction mixture prior to polymerization and polyurethane formation, for example expressed as an amount relative to lignin alone or an amount relative to the combined amount of lignin, natural oil polyol, and internal emulsifier added to the reaction mixture.

In some embodiments, carboxylic groups present in the polyurethane polymer, for example from the internal emulsifier, lignin, or both, can be neutralized with a neutralizing agent. For example, a tertiary amine (e.g., triethylamine) neutralizing agent can be used to provide compatibility with and stability in an aqueous/water medium due to formed ions (e.g., a quaternary ammonium analog of the tertiary amine as a counter-cation to the carboxylate anion in solution), thus serving as an emulsifier for the polyurethane. A suitable tertiary amine can be represented by NR¹R²R³, where R¹, R², and R³ can be the same or different alkyl groups having 1, 2, 3, 4 carbon atoms and/or up to 6, 8, or 10 carbon atoms. A corresponding quaternary ammonium can be represented by NR¹R²R³H⁺, where R¹, R², and R³ are as described above. Thus, in some embodiments, the internal emulsifier can include a quaternary ammonium group (e.g., from the original neutralizing agent) and a carboxylate group (e.g., from the original carboxylic acid group in the internal emulsifier), for example as present in the dispersion. The neutralizing agent likewise can remain in an applied, dried coating after water/solvent removal (e.g., for example in its tertiary amine form). An example of a suitable internal emulsifier includes tartaric acid, which is a natural/biobased internal emulsifier. Another suitable internal emulsifier includes dimethylol propionic acid (DMPA).

The neutralizing agent can be incorporated into the reaction product in an amount of 5 wt. % to 30 wt. % relative to the lignin. For example, the neutralizing agent can be incorporated into the reaction product in an amount of at least 5, 7, 10, 15, 20, or 25 wt. % and/or up to 10, 15, 20, 25, or 30 wt. % relative to the lignin. The foregoing amount ranges likewise can apply to the amount of incorporated neutralizing agent relative to the combined amount of lignin, natural oil polyol, and internal emulsifier (i.e., total hydroxy functional components) incorporated into the reaction product. Yet further, the foregoing amount ranges likewise can apply to the amount of neutralizing agent added to a reaction mixture after or during polymerization and polyurethane formation, for example expressed as an amount relative to lignin alone or an amount relative to the combined amount of lignin, natural oil polyol, and internal emulsifier added to the reaction mixture.

In some embodiments, the lignin, the natural oil polyol (when present), and the internal emulsifier (when present) can provide substantially all of the urethane linking groups in the reaction product. The lignin, natural oil polyol (when present), and internal emulsifier (when present) can represent an essentially complete replacement for petroleum-based polyols such that essentially all of the urethane/carbamate linking groups in the polyurethane are derived from reaction products between the isocyanate and the hydroxyl groups of the lignin, natural oil polyol, or internal emulsifier. For example, at least 70, 80, 90, 95, 98, 99% and/or up to 90, 95, 98, 99, 100% of the urethane/carbamate linking groups are derived from reaction products between the isocyanate and the hydroxyl groups of the lignin, natural oil polyol, or internal emulsifier. Similarly, at least 70, 80, 90, 95, 98, 99 wt. % and/or up to 90, 95, 98, 99, 100 wt. % of the hydroxyl-containing reactants used to form the polyurethane reaction product are lignin, natural oil polyol, or internal emulsifier. Alternatively or additionally, not more than 20, 10, 5, 2, or 1% of the urethane/carbamate linking groups are derived from petroleum-based hydroxyl-containing sources or hydroxyl-containing sources other than lignins, natural oil polyols, and internal emulsifiers, for example with analogous wt. % upper limits on hydroxyl-containing reactants derived from petroleum-based hydroxyl-containing sources.

In other embodiments, the lignin, the natural oil polyol (when present), and the internal emulsifier (when present) can provide only a portion of the urethane linking groups in the reaction product. In this case, the lignin, natural oil polyol (when present), and internal emulsifier (when present) can represent a partial replacement for petroleum-based polyols such that (i) a portion of the urethane/carbamate linking groups in the polyurethane are derived from reaction products between the isocyanate and the hydroxyl groups of the lignin, natural oil polyol, or internal emulsifier, and (ii) a portion of the urethane/carbamate linking groups in the polyurethane are derived from reaction products between the isocyanate and hydroxyl groups of a petroleum-based or other polyol. For example, at least 30, 40, or 50% and/or up to 50, 60, 70, 80, 90, or 95% of the urethane/carbamate linking groups are derived from reaction products between the isocyanate and the hydroxyl groups of the lignin, natural oil polyol, or internal emulsifier. Similarly, at least 30, 40, or 50 wt. % and/or up to 50, 60, 70, 80, 90, or 95 wt. % of the hydroxyl-containing reactants used to form the polyurethane reaction product are lignin, natural oil polyol, or internal emulsifier. Alternatively or additionally, at least 5, 10, 20, 30, 40, or 50% and/or up to 50, 60, or 70% of the urethane/carbamate linking groups are derived from reaction products between the isocyanate and the hydroxyl groups of the petroleum-based or other polyol. Similarly, at least 5, 10, 20, 30, 40, or 50 wt. % and/or up to 50, 60, or 70 wt. % of the hydroxyl-containing reactants used to form the polyurethane reaction product are petroleum-based or other polyols. Example petroleum-based and other polyols include diols, triols, and polyols with two, three, four, or more hydroxyl groups such as glycerol, ethylene glycol, diethylene glycol, triethylene glycol, tetraethylene glycol, propylene glycol, dipropylene glycol, tripropylene glycol, 1,3-propanediol, 1,3-butanediol, 1,4-butanediol, neopentyl glycol, 1,6-hexanediol, 1,4-cyclohexanedimethanol, glycerol, trimethylolpropane, 1,2,6-hexanetriol, and pentaerythritol, as well as polyether polyols, polyester polyols, etc.

In embodiments, the polyurethane dispersion has a solids content in a range of 10 wt. % to 50 wt. %, 25 wt. % to 60 wt. %, or 30 wt. % to 70 wt. % relative to the polyurethane dispersion. For example, the polyurethane dispersion can have a solids content of at least 10, 15, 20, 25, 30, 35, 40, 45, or 50 wt. % and/or up to 20, 25, 30, 35, 40, 45, 50, 55, 60, 65, or 70 wt. % relative to the relative to the polyurethane dispersion. The solids content can reflect the weight of solid residue remaining after removal and drying of the liquid dispersion medium, including water as the primary portion of the aqueous medium and any secondary solvents, expressed relative to the initial weight of the dispersion. Alternatively, the solids content can be expressed as a weight concentration of the dispersed polyurethane reaction product relative to the total dispersion weight. Prior to final drying to form a coating or layer of the polyurethane on a substrate, the solids content of the dispersion can be increased by at least partial evaporation or removal or suspending solvents, for example removing all or substantially all of MEK or other volatile organic solvent used during polymerization as well as removal of at least some water added to the reaction product mixture to create an initial dispersion. For example, an polyurethane dispersion as initially formed upon addition of water might have a solids content of about 10 wt. %, which can be increased to about 30 wt. %, about 50 wt. %, or more by removing the volatile organic reaction medium solvent and some water, while retaining sufficient water for an aqueous medium and a stable dispersion.

In embodiments, the polyurethane dispersed in the aqueous medium (e.g., the solids portion of the dispersion) is in the form of polyurethane particles having a size in a range of 30 nm to 200 nm. For example, the polyurethane particles can have a size of at least 30, 50, 80, or 100 nm and/or up to 70, 100, 150, or 200 nm. The foregoing ranges can represent an average size (e.g., volume, number, or weight average) or high/low for cumulative size distribution (e.g., 10/90%, 5/95% cuts of the cumulative size distribution).

In some embodiments, the polyurethane dispersion is substantially free from cyclic alkyl carbonates. This can include cyclic alkyl carbonates used as a solvent and/or a reactive solvent reacts with and is incorporated into the polyurethane polymer. Thus, the polyurethane dispersion as a whole, the aqueous medium component thereof, and/or the polyurethane component thereof suitably contain not more than 10, 5, 2, 1, 0.5, 0.2, or 0.1 wt. % cyclic alkyl carbonates, whether in carbonate form or as a ring-opened and isocyanate-reacted residue in the polyurethane. Examples of representative cyclic alkyl carbonates include propylene carbonate, ethylene carbonate, trimethylene carbonate, butylene carbonates (e.g., derived from one or more butanediols such as 1,2-, 1,3-, 1,4-, or 2,3-butanediol), pentylene carbonates (e.g., derived from one or more pentanediols), etc.

The polyurethane dispersion according to the disclosure can be formed by reacting an (initial) reactant mixture containing the isocyanate, the lignin, the natural oil polyol (when included), and the internal emulsifier (when included) in an organic solvent medium, for example including cyrene and one or more volatile solvents such as MEK. A resulting polyurethane reaction product is formed in the organic solvent medium. Water is then added to the organic solvent medium to form dispersed polyurethane particles in the resulting liquid medium including the water and the original organic solvents. Then, at least a portion of the organic solvent medium is removed from the liquid medium, for example the volatile or relatively more volatile solvent (e.g., removing the volatile MEK component, leaving the less volatile cyrene component in the liquid medium). This forms a resulting aqueous medium with the polyurethane polymer (e.g., polyurethane polymer particles) dispersed in the aqueous medium. The initial reacting step is suitably performed under a nitrogen, argon, etc. or other inert, essentially water-free (i.e., to avoid reaction with isocyanate groups) atmosphere at an elevated temperature of about 50-100° C. Addition of the water to the organic solvent medium is suitably performed under high shear conditions (e.g., at/above 500 rpm mixing rates). The initial organic solvent medium can include a water-soluble solvent, for example including cyrene or other aprotic or biobased secondary solvents as described above. Suitable co-solvents for the water-miscible solvent in the initial organic solvent medium can include volatile or other organic solvents such as acetone, methyl ethyl ketone (MEK), dioxane, acetonitrile, ethyl acetate, and tetrahydrofuran. After formation of the dispersed polyurethane particles, removal of the co-solvent (e.g., MEK) via evaporation can remove some of the added water and/or some of the water-miscible solvent.

After polymerization and prior to addition of the water, one or more additional components can be added to the reaction mixture, for example for incorporation into the final polyurethane product. Such additional components can include a neutralizing agent as described above, for example a tertiary amine or otherwise. Other such additional components can include a terminating/chain extending agent, for example a primary amine (e.g., monoamine terminating agent) or a primary polyamine (e.g., diamine or higher polyamine chain extending/terminating agent). For example, a hydrazine or other primary amine (or primary diamine) can slowly be added to the reaction mixture to consume remaining isocyanate functional groups. The hydrazine or primary amine is added slowly to the isocyanate-terminated prepolymer to attach two isocyanate end groups chains together. It is preferable to react with two separate isocyanate-terminated prepolymer chains (i.e., chain extension), but also it is possible to react with multiple isocyanate-terminated prepolymer groups in the same molecule (i.e., chain termination). The use of hydrazine is helpful to avoid or reduce the chance of second reaction.

### Coated Article

In another aspect, the disclosure relates to an article incorporating the polyurethane polymer, for example in a coated article or adhesive-bound article. Such articles generally include a substrate; and a polyurethane polymer according to the disclosure coated on a surface of the substrate. The polyurethane polymer coating generally includes the polyurethane reaction product remaining as a film or layer on a substrate after drying or other removal of the aqueous medium components of the dispersion, which in turn causes the polyurethane particles in the dispersion to coalesce into a continuous coating layer. Typically, the polyurethane polymer as formed in the polyurethane dispersion is a fully reacted product and there is no chemical reaction or curing during the drying process. When there is a single substrate, the polyurethane polymer can serve an outer (protective) coating on the substrate. When there are two substrates, polyurethane polymer can serve as an adhesive coating between two bound substrates.

FIGS. 2 and 3 illustrate an aspect of the disclosure in which an article 300 includes one or more substrates 200, 210, 220 and a polyurethane polymer 100 coated on, bound to, or otherwise adhered to one or more substrate surfaces 202, 212, 222. More particularly, FIG. 2 illustrates a coated article 300 in which the polyurethane polymer 100 is coated on a surface 202 of the substrate 200. The polyurethane polymer 100 can be in the form of an external, environment-facing coating or film on what would otherwise be an external, environment-facing surface 202 of the substrate 200 (e.g., where the surface 202 would otherwise be exposed to the external environment in the absence of the polymer 100). In this case, the polyurethane polymer 100 provides protection to the underlying substrate 200. FIG. 3 illustrates an adhesively joined article 300 in which the polyurethane polymer 100 is coated on or adhered to a first substrate 210 and an opposing second substrate 220 at a corresponding first surface 212 and a corresponding second surface 222, respectively. In this case, the polyurethane polymer 100 can function as an adhesive joining the two substrates 210, 220 together at an interior location between the substrates. The substrates 210, 220 can be the same or different materials.

The substrate is not particularly limited in either embodiment, and generally can be formed from any material desired for protection with a coating and/or joined with an adhesive. For example, the substrate can be a metal, plastic, a different thermoset or thermoplastic polymer material (e.g., a primer material; material other than the polyurethane polymer), glass, wood, fabric (or textile), or ceramic material. Examples of specific metals include steel, aluminum, copper, etc. Examples of specific plastics include polyvinyl alcohol (PVOH), ethylene vinyl alcohol (EVOH), polyethylene terephthalate (PET), polypropylene (PP), polyethylene (PE), polylactic acid (PLA), starch, chitosan, etc. In an embodiment, the substrate can be in the form of a three-dimensionally printed substrate, whether formed from a polymeric/plastic material or otherwise. Suitable wood materials can be any type of wood commonly used in home, office, and outdoor settings. Suitable glass materials can be those used for building windows, automobile windows, etc. In some embodiments, the substrate is a top layer of a coating or series of coatings on a different underlying substrate. For example, the coated article can include a substrate material as generally disclosed herein, one or more intermediate coatings on the substrate (e.g., an epoxy coating, an acrylic coating, another primer coating, etc.), and the polyurethane polymer on the one or more intermediate coatings as the final, external coating on the coated article.

The polyurethane polymer coating can have any desired thickness on the substrate. In common applications, the coating has a thickness ranging from 0.010 μm to 500 um, for example at least 0.01, 10, 20, 50, or 100 μm and/or up to 200, 500 μm. Typical cast coatings can have thicknesses of 10 μm to 100 μm. Typical spin coatings can have thicknesses of 0.05 μm or 0.10 μm to 0.20 μm or 0.50 μm. Multiple coating layers can be applied to substrate to form even thicker layers of the polyurethane polymer (e.g., above 500 μm or otherwise) if desired.

The article according to the disclosure (e.g., coated article, adhesive-bound article, etc.) can be formed by applying a polyurethane dispersion according to the disclosure to a surface of a substrate by any suitable means such as spraying, dipping, rolling, etc. In embodiments including two substrates adhesively joined by the polyurethane, a second (opposing) substrate can then be contacted with the applied polyurethane dispersion (e.g., as initially applied or after some partial (but not complete) drying). Then, at least a portion of the aqueous medium is removed from the applied polyurethane dispersion, which is generally applied as a wet or liquid applied layer of dispersion. Such (partial or essentially complete) removal of water any supporting organic solvent can be effected via drying or heating at ambient or elevated temperature. As a result, a polyurethane polymer is formed as a (continuous) layer on the substrate, for example where the polyurethane particles remaining after removal of liquid dispersion components coalesce into a coating or adhesive layer.

### EXAMPLES

The following examples illustrate the disclosed compositions and methods, but are not intended to limit the scope of any claims thereto. In the following examples, waterborne polyurethane dispersions (PUDs) generally according to the disclosure were prepared and applied as a film or coating on a test substrate such as wood. In particular, lignin-based PUD formulations were prepared using two approaches to modify and improve the PUD formulations. Tartaric acid (TA) was used as an emulsifier to replace dimethylol propionic acid (DMPA) and increase the percentage of biobased reagent in PUD formulation. In addition, a soy-based polyol with a low hydroxyl (OH) value was added to the formulation to increase the flexibility and elongation of lignin-based PUD. The applied films or coatings were evaluated as described below in order to characterize their mechanical properties.

Materials: Hardwood lignin isolated from alkaline pre-extraction pretreatment was used. Isophorone diisocyanate (IPDI), hexamethylene diisocyanate (HDI), dimethylol propionic acid (DMPA), tartaric acid (TA), methyl ethyl ketone (MEK), and triethylamine (TEA) were purchased from Fisher Scientific. Hydrazine monohydrate (HZ), and cyrene were supplied from Sigma Aldrich. The soy-based polyol with OH value of 40 mg KOH/g was supplied by Cargill.

Synthesis of Lignin-Based PUD Resins: First, 5 g dried alkaline pre-extraction lignin was dissolved in 25 g cyrene and 80 g MEK. Then, different formulations were prepared as summarized in Table 1. The mixture of lignin, emulsifier, and isocyanate was mixed under reflux and a nitrogen atmosphere at 70° C. for 4 hours. Then, it was cooled to 50° C., and TEA was added as a neutralizing agent and mixed for 1 hour. Next, an equivalent amount of HZ was gradually added at room temperature to react with the remaining isocyanate (NCO) groups to complete the polymerization step. Finally, 40 g DI water was added to the mixture at a high shear rate (2000 rpm) to disperse the formed PUD particles. A rotary evaporator at 50° C. was employed to remove MEK from the solution. A commercial PUD resin from WIL was used as a reference for comparison with lignin-based formulations.

TABLE 1
Components of tested PUD formulations

| | | Soy- | | Triethyl- | | |
|---|---|---|---|---|---|---|
| | Lignin | polyol | Tartaric | amine | Isocyanate | |
| Sample ID | (g) | (g) | acid (g) | (g) | (g) | |
| 1) Pre-ex | 5 | — | 1 | 1.3 | 4.4 | (IPDI) |
| IPDI-PUD | | | | | | |
| 2) Pre-ext | 5 | — | 1 | 1.3 | 3.3 | (HDI) |
| HDI-PUD | | | | | | |
| 3) Pre-ext 10% | 4.5 | 0.5 | 1 | 1.3 | 3.1 | (HDI) |
| soy HDI-PUD | | | | | | |
| 4) Pre-ext 20% | 4 | 1 | 1 | 1.3 | 2.6 | (HDI) |
| soy HDI-PUD | | | | | | |
| 5) Pre-ext 30% | 3.5 | 1.5 | 1 | 1.3 | 2.4 | (HDI) |
| soy HDI-PUD | | | | | | |

Characterization of Lignin-Based PUDs: The solids content of all resins was measured according to the ASTM D4426-01. First, aluminum pans were placed in a furnace at 270° C. for 1-2 min to burn off any contamination. Then the samples were cooled to room temperature in a desiccator and weighted. Then, around 1 g of resin was added to a pan and placed in an oven for 105 min at 125° C. Later, samples were moved to a desiccator to reach room temperature and then weighed. The solid content of resins was calculated according to the following equation: solids content (%)=(wt. dried resin)/(wt. initial resin)×100. The pH of all resins was measured using a calibrated Mettler Toledo S220 pH meter at room temperature. Viscosity measurements were performed using a DISCOVERY HR-1 hybrid rheometer (TA instrument) at room temperature (about 25° C.) and at a constant shear rate (100 1/s).

The PUD resins were formed into test films for tensile strength measurement by adding the resins to a silicon mold and dryinh at room temperature for 72 hrs. Then, the formed films were taken out and subjected to a micro-tensile test, using an Instron universal testing machine, to measure the tensile strength and elongation at break. The sample dimensions were 25 mm×5 mm×1 mm, and the elongation rate was 500 mm/min.

Results: Cyrene (dihydrolevoglucosenone) is a heterocyclic cycloalkanone that is made either by hydrogenation, or enzymatic reduction of levoglucosenone. Cyrene is a commercially available biobased solvent and is considered a green alternative for toxic aprotic solvents such as dimethylformamide (DMF) and N-methyl-2-pyrrolidone (NMP). DMF is a good solvent for lignin due to their relatively low Hansen relative energy difference (RED), which is 0.77 for DMF and lignin. Because of similar aprotic dipolar properties to DMF, the RED of lignin and cyrene is 0.89, indicating that cyrene is can be a good solvent for lignin. Therefore, cyrene was used to dissolve lignin for further reaction in PUD formulations. Table 2 shows the properties of prepared PUD resins. In addition to the PUDs summarized in Table 1 that were formed using alkaline pre-extraction lignin, further PUDs according to the disclosure were also formed using two-stage alkaline pre-extraction/copper-catalyzed alkaline hydrogen peroxide (Cu-AHP) lignin using different peroxide levels as shown in Table 2, as well as a comparative commercially available PUD. The PUD resins in Table 2 were applied as test coatings (8 mil or 203 micron wet thickness) to wood substrates.

TABLE 2
Properties of PUD resins

| | Solid Content | | Viscosity |
|---|---|---|---|
| Sample ID | (%)^{a} | pH | (cP)^{b} |
| Pre-extraction PUD | 33.7 (0.5) | 8.0 | 228 |
| Cu-AHP (1.2% H₂O₂ + O₂) | 31.8 (0.4) | 8.2 | 211 |
| PUD | | | |
| Cu-AHP (4% H₂O₂ + O₂) PUD | 34.2 (0.3) | 7.9 | 234 |
| Commercial PUD | 34.9 (0.2) | 8.1 | 240 |

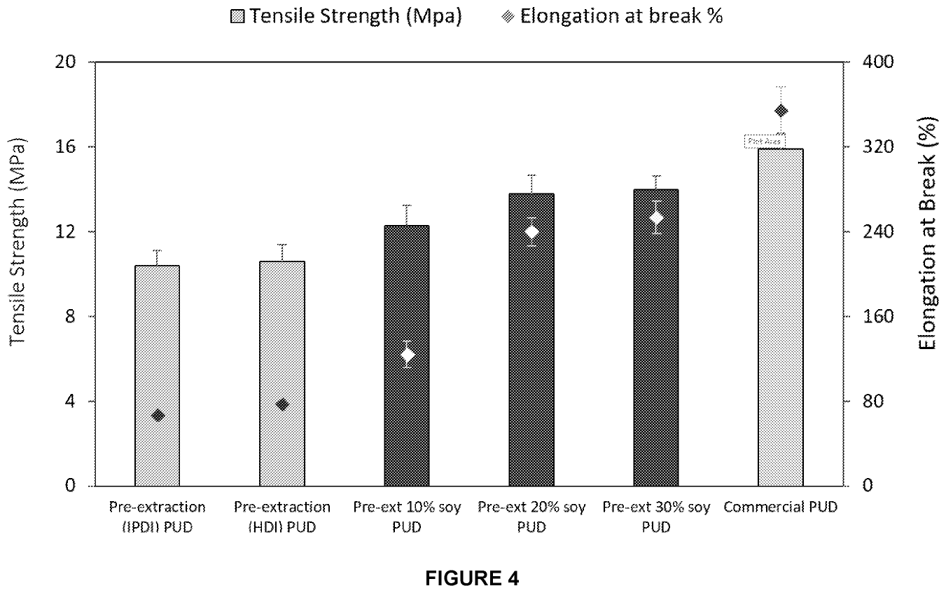

Films formed from the PUDs as described above were tested for the their mechanical properties, and the results are shown in FIG. 4. The sample prepared with IPDI showed low tensile strength and significantly lower elongation at break than the commercial PUD. HDI was used as an isocyanate reagent to improve the elongation at the break of PUD films since it has a linear structure. It was found that replacing IPDI with HDI did not substantially improve the tensile properties of PUD film. Therefore, a soy-polyol with a low hydroxyl value was used to partially replace the lignin to provide flexibility (i.e., at 10, 20, and 30 wt. % levels of soy-polyol comprared to total lignin+soy-polyol). By adding 10 wt. % soy-polyol, the elongation at break and tensile strength increased by 160% and 116%, respectively, compared with lignin-based PUD formulated with HDI. Both tensile strength and elongation at break continued to increase with higher incorporation of soy-polyol, but the increase rate plateaued from 20wt. % to 30 wt. % soy-polyol. The lignin-based PUD formulation with 20% soy-polyol displayed a tensile strength that was 88% of the commercial PUD's tensile strength; similarly, its elongation to break was 68% of the commercial PUD's corresponding value.

Because other modifications and changes varied to fit particular operating requirements and environments will be apparent to those skilled in the art, the disclosure is not considered limited to the example chosen for purposes of illustration, and covers all changes and modifications which do not constitute departures from the true spirit and scope of this disclosure.

Accordingly, the foregoing description is given for clearness of understanding only, and no unnecessary limitations should be understood therefrom, as modifications within the scope of the disclosure may be apparent to those having ordinary skill in the art.

All patents, patent applications, government publications, government regulations, and literature references cited in this specification are hereby incorporated herein by reference in their entirety. In case of conflict, the present description, including definitions, will control.

Throughout the specification, where the compositions, processes, kits, or apparatus are described as including components, steps, or materials, it is contemplated that the compositions, processes, or apparatus can also comprise, consist essentially of, or consist of, any combination of the recited components or materials, unless described otherwise. Component concentrations can be expressed in terms of weight concentrations, unless specifically indicated otherwise. Combinations of components are contemplated to include homogeneous and/or heterogeneous mixtures, as would be understood by a person of ordinary skill in the art in view of the foregoing disclosure.

1. A waterborne polyurethane dispersion (PUD) comprising:
an aqueous medium comprising water; and
a polyurethane dispersed in the aqueous medium, the polyurethane comprising a reaction product between monomer components comprising:
an isocyanate, and
a lignin comprising aliphatic hydroxyl groups and having an aliphatic hydroxyl content of at least 2 mmol/g;
wherein the reaction product comprises urethane linking groups between residues of the lignin aliphatic hydroxyl groups and the isocyanate.

2. The polyurethane dispersion of claim 1, wherein the isocyanate comprises a diisocyanate.

3. The polyurethane dispersion of claim 1, wherein the isocyanate is selected from the group consisting of hexamethylene diisocyanate (HDI), isophorone diisocyanate, 4,4′-diphenylmethane diisocyanate (MDI), polymeric methylene diphenyl diisocyanate (pMDI), one or more isomers of tolylene diisocyanate (TDI), and combinations thereof.

4. The polyurethane dispersion of claim 1, wherein the lignin is derived from a hardwood biomass and is isolated from an alkaline pre-treatment or enzymatic hydrolysis process.

5. The polyurethane dispersion of claim 1, wherein the lignin is derived from a biomass selected from the group consisting of hardwoods, softwoods, grasses, and combinations thereof.

6. The polyurethane dispersion of claim 1, wherein the lignin is isolated from an extraction process selected from the group consisting of Kraft extraction, soda extraction, organosolv extraction, enzymatic hydrolysis extraction, ionic liquid, extraction, sulfite extraction, and combinations thereof.

7. The polyurethane dispersion of claim 1, wherein the lignin, prior to incorporation into the reaction product, has at least one of the following properties:
a molecular weight in a range of 500 to 20000;
a polydispersity in a range of 1.2 to 8;
an aliphatic hydroxyl content in a range of 4 to 8 mmol/g;
a phenol hydroxyl content in a range of 1 to 6 mmol/g;
a carboxylic hydroxyl content less than 1 mmol/g; and
a total hydroxyl content in a range of 5 to 14 mmol/g.

8. The polyurethane dispersion of claim 1, wherein:
the monomer components further comprise a natural oil polyol; and
the reaction product further comprises urethane linking groups between residues of the natural oil polyol and the isocyanate.

9. The polyurethane dispersion of claim 8, wherein the natural oil polyol is incorporated into the reaction product in an amount of 5 wt. % to 50 wt. % relative to the lignin.

10. The polyurethane dispersion of claim 1, wherein:
the monomer components further comprise an internal emulsifier; and
the reaction product further comprises urethane linking groups between residues of the internal emulsifier and the isocyanate.

11. The polyurethane dispersion of claim 10, wherein the internal emulsifier comprises a quaternary ammonium group and a carboxylate group.

12. The polyurethane dispersion of claim 10, wherein the internal emulsifier is incorporated into the reaction product in an amount of 5 wt. % to 30 wt. % relative to the lignin.

13. The polyurethane dispersion of claim 1, wherein;
the monomer components further comprise a natural oil polyol and an internal emulsifier;
the reaction product further comprises urethane linking groups between (i) residues of the natural oil polyol and the isocyanate, and (ii) residues of the internal emulsifier and the isocyanate; and
the lignin, the natural oil polyol , and the internal emulsifier provide substantially all of the urethane linking groups in the reaction product.

14. The polyurethane dispersion of claim 1, wherein;
the monomer components further comprise a natural oil polyol and an internal emulsifier:
the reaction product further comprises urethane linking groups between (i) residues of the natural oil polyol and the isocyanate, and (ii) residues of the internal emulsifier and the isocyanate; and
the lignin, the natural oil polyol, and the internal emulsifier provide 30% to 95% all of the urethane linking groups in the reaction product.

15. The polyurethane dispersion of claim 1, wherein the polyurethane dispersion has a solids content in a range of 10 wt. % to 70 wt. % relative to the polyurethane dispersion.

16. The polyurethane dispersion of claim 1, wherein the aqueous medium further comprises a water-miscible solvent.

17. The polyurethane dispersion of claim 16, wherein the water-miscible solvent comprises cyrene (dihydrolevoglucosenone).

18. The polyurethane dispersion of claim 1, wherein the aqueous medium is present in the polyurethane dispersion in a range of 30 wt. % to 90 wt. % relative to the polyurethane dispersion.

19. The polyurethane dispersion of claim 1, wherein the water is present in the aqueous medium in an amount of at least 50 wt. % relative to the aqueous medium.

20. The polyurethane dispersion of claim 1, wherein the polyurethane dispersed in the aqueous medium is in the form of polyurethane particles having a size in a range of 30 nm to 200 nm.

21. The polyurethane dispersion of claim 1, wherein the polyurethane dispersion is substantially free from cyclic alkyl carbonates.

22. A method for making a polyurethane dispersion according to claim 1, the method comprising:
reacting a reactant mixture comprising the isocyanate, the lignin, optionally the an natural oil polyol, and optionally the an internal emulsifier in an organic solvent medium, thereby forming the polyurethane reaction product in the organic solvent medium;
adding water to the organic solvent medium, thereby forming dispersed polyurethane particles; and
removing at least a portion of the organic solvent medium, thereby forming the aqueous medium with the polyurethane dispersed in the aqueous medium.

23. An article comprising:
(a) a substrate; and
(b) a polyurethane polymer according to claim 1, coated on a surface of the substrate.

24. The article of claim 23, wherein the substrate is selected from the group of metal, plastics, a different polymer material, glass, wood, fabric (or textile), composites, and ceramics.

25. The article of claim 23, wherein the polyurethane polymer has a thickness ranging from 0.01 μm to 500 μm.

26. The article of claim 23, further comprising an additional substrate, wherein:
the polyurethane polymer is also coated on a surface of the additional substrate, and the polyurethane polymer joins the substrate and the additional substrate together.

27. A method for forming an article according to claim 23, the method comprising:
applying the polyurethane dispersion according to claim 1 to the a substrate; and
removing the aqueous medium from the applied polyurethane dispersion, thereby forming a polyurethane polymer as a layer on the substrate.

28. The polyurethane dispersion of claim 1, wherein:
the lignin is incorporated into the reaction product in an amount of 20 wt. % to 80 wt. % relative to the polyurethane; and
the isocyanate is incorporated into the reaction product in an amount of 20 wt. % to 80 wt. % relative to the polyurethane.

29. The polyurethane dispersion of claim 28, wherein:
the polyurethane dispersion has a solids content in a range of 10 wt. % to 70 wt. % relative to the polyurethane dispersion;
the aqueous medium is present in the polyurethane dispersion in a range of 30 wt. % to 90 wt. % relative to the polyurethane dispersion; and
the polyurethane dispersed in the aqueous medium is in the form of polyurethane particles having a size in a range of 30 nm to 200 nm.

30. The polyurethane dispersion of claim 29, wherein:
the lignin is derived from a hardwood biomass and is isolated from an alkaline pre-treatment; and
the aqueous medium further comprises a water-miscible aprotic solvent.

31. The polyurethane dispersion of claim 30, wherein:
the monomer components further comprise a natural oil polyol and an internal emulsifier;
the reaction product further comprises urethane linking groups between (i) residues of the natural oil polyol and the isocyanate, and (ii) residues of the internal emulsifier and the isocyanate;
the natural oil polyol is incorporated into the reaction product in an amount of 5 wt. % to 50 wt. % relative to the lignin; and
the internal emulsifier is incorporated into the reaction product in an amount of 5 wt. % to 30 wt. % relative to the lignin.
